(19) United States
(12) Patent Application Publication
(10) Pub. No.: US 2014/0280310 A1
(43) Pub. Date: Sep. 18, 2014

(54) COMPUTER IMPLEMENTED SEARCH SYSTEM

(71) Applicants: Kourosh Gohar, Los Angeles, CA (US); Tony Rhoton, American Fork, UT (US); Todd M. Zebert, Encino, CA (US); Jackie Chang, Los Angeles, CA (US)

(72) Inventors: Kourosh Gohar, Los Angeles, CA (US); Tony Rhoton, American Fork, UT (US); Todd M. Zebert, Encino, CA (US); Jackie Chang, Los Angeles, CA (US)

(73) Assignee: KUYAM COMPANIES INC., Los Angeles, CA (US)

(21) Appl. No.: 13/872,023

(22) Filed: Apr. 26, 2013

Related U.S. Application Data
(63) Continuation-in-part of application No. 13/837,413, filed on Mar. 15, 2013.

(51) Int. Cl. G06F 17/30

(52) U.S. Cl. CPC G06F 17/30424
USPC 707/769

(57) ABSTRACT

A computer implemented method of searching for services desired by a user comprising compiling a database of establishments available for the user to search, the database comprising a profile about each establishment, the profile comprising the establishment's category of services provided, the location and the available appointment days and times for providing the services, and providing a search program operable by a computer processor accessible by a user operating a computer or a mobile device in which the user can search for a service by selecting one or more of a category of service, name of an establishment, a location, or a date and time available for an appointment and the user can confirm an available appointment with an establishment directly from their own computer or mobile device.

This application is a continuation-in-part application of U.S. patent application Ser. No. 13/837,413 filed Mar. 15, 2013, which application is incorporated herein by reference, in its entirety.

### FIELD OF THE INVENTION

The present invention comprises a platform that acts as a marketplace which empowers its users, the buyers of listed services and its establishments, the sellers of listed services, the capabilities to search, discover, schedule, share and store a user based schedule.

### BACKGROUND OF THE INVENTION

Technology has provided public and private establishments with many means for consumers to schedule appointments. Consumers can make an appointment with an establishment over the phone or via email. Some establishments even offer consumers an option to schedule appointments online by visiting the establishment's website. While technology has made this process easier, consumers who wish to make appointments with multiple establishments have to make several phone calls, and/or log onto several different websites for each establishment. Furthermore, most establishments still lack the means to allow consumers to make appointments online. These limitations waste valuable time and are mistake prone. There is a need to provide consumers with a single integrated platform, a “one stop shop”, which allows consumers to make, modify or cancel online appointments, all on one platform.

There is also a need for a more effective search system that makes it easier for a user to find and learn about companies and businesses and book appointments with them.

### SUMMARY OF THE INVENTION

The invention described herein is an improvement over the system set forth in the parent application referred to above. The improvement adds to the platform described in the parent application, means to easily and effectively search using the platform web site or using a mobile phone or smartphone, to find a company or business for which the user has a need. This can be accomplished using the search web site through searching for a specific category, type of business, favorite businesses tagged by the user and/or previous purchased packages. The search can also be made by selecting category icons that represent the services that the establishments offer through the platform.

The search using a mobile phone or smartphone allows the user to search for a company by typing a specific service category or a company name. The search can also be made based upon location using geo-location functions of the mobile device to locate the closest business establishment to the user's mobile device. The search can be directed to the current location or a selected other location or by accessing a previously searched or visited location.

The search can also be based upon a selection of the day and/or time or by selecting a one click category button which will access the businesses so available in the search results. The flexibility of the different search options provides a much better user experience.

The search results will be flexible in that the platform administrator can adjust the search results by enhancing a company's position in the listings based on, for instance, highest user reviews, most available time slots, most appointments booked, and other factors of importance to users.

In addition, the platform has certain features that are available for the user, such as, find and search appointments, review appointment status, history of completed appointments and the ability to review prior receipts for appointment transactions, while also viewing the user's calendar along with any synced third party calendars. Once the user logs in to the system there is a dashboard that is present on most all screens that gives quick access to the above mentioned features.

Some of the search features outlined above, as well as the dashboard, may be available only for the users of the platform after a user has signed up and logged onto the platform.

These search features are part of the single platform described in the parent application which is capable of setting up various appointments with different establishments, described in detail in the parent application. By providing its users with a single platform capable of making appointments with different establishments, this system saves its users time spent on logging onto multiple websites or making several phone calls in order to make appointments with different establishments. The system also creates an online platform to help its users to organize their schedules. The system also allows its users to arrange group meetings, and create or schedule live events using a single integrated platform.

The platform offers its users a convenient method to view the establishments' availability calendar and an option for the user to superimpose the user's own third party calendars (such as Google Calendar, iCal or Facebook events) on top of the establishments' availabilities. The user can also superimpose the establishment's availabilities over the user's own third party calendars. The platform also allows users to book appointments with the establishments directly through the platform. In addition, the platform allows users to create, schedule and initiate events with other users (such as play dates, rideshares, etc.)

It is an object of the present invention to provide an improved search system for the platform which is capable to search, discover, schedule, share and/or store a user based schedule. It is a further object of the present invention to provide its users to be able to search and find one or more establishments that they need and to set up appointments with each establishment, on one calendar.

The description of the platform is described in detail in the parent application and is incorporated herein by reference, in its entirety.

When a user searches and finds a company or establishment that may provide the needed services, a company profile page for each of the establishments found will be shown, with a built in clock and an integrated calendar. The company profile page includes a calendar with any and all available time slots, associated with specific services and in some cases, a specific employee for the establishment. In addition to the company's profile page calendar, there is a real world calendar which is divided into months, weeks, days, and may also have an agenda or list format.

The platform contains a function which allows users to search the list of establishments for a desired establishment to make an appointment, and search the list of available time slots of establishments to make an appointment. The user can choose to make an appointment with any establishment on the list of establishments by allotting an increment of time in the calendar for the designated establishment. If a user cannot find the type of establishment he or she is searching for, the platform contains a feature which allows the user to request an establishment be added to the platform.

The platform also contains a feature which allows its users to tag an establishment as the user's favorite establishment, resulting in listing the tagged favorite establishment in the user's “select a favorite” category, with a dropdown button for ease of use.

### BRIEF DESCRIPTION OF THE DRAWINGS

FIG. 1 is a diagram illustrating the step by step operation of the search system;

FIG. 2 shows a mobile version search page and a mobile version search results page.

FIG. 3 shows a mobile version map display and a mobile version map display after selecting a pin.

### DETAILED DESCRIPTION

Referring to the drawings, FIG. 1 shows the steps taken to utilize the search system of the invention. Step 1 the user taps the search button 130 to commence a search. Step 2 the search page appears. At that point in Step 3 the user has several options:

Option A to search by entering the name of a company, a service needed or a category;
Option B to search by their current location or a specific other location;
Option C search by the day of the week availability;
Option D search by time availability; or,

Step 4 search by category buttons.

If the user chooses Option B, Step 5 the user can select their current location or enter a different location.

If the user chooses Option C Step 6 the user can select any day or a specific day.

If the user chooses Option D Step 7 the user can select any time or a specific time of day.

This takes the user into Step 8, Option A which provides availability results which are listed matching the words searched from the most relevant to the least relevant. Step 8, Option B where availability results are listed matching the user's location search from the nearest to the farthest. Step 8, Option C where availability results are listed matching the user's day of the week preference. Step 8, Option D where availability results are listed matching the user's time preference. Step 8, Option E where availability results are listed matching the category selected.

At that point, Step 9 if the user cannot find it, the user taps ‘can't find it’, add a company button and at Step 10 the user can add a company they 155 want added to the database.

At Step 11 the user taps ‘map’ display option, at Step 12 a map is displayed with icons or pins representing companies in the search results. Step 13 the user taps a pin on the map which takes the user to Step 14 where a specific company's information is displayed and available times are shown above the map. This proceeds to Step 23 where the user taps an available time slot and the system progresses to Steps 26 through 30, explained below.

Alternatively, the user can go from Step 12 to Step 15 where the user can drag around the map and zoom to a certain area, then go to Step 16 where the user clicks a ‘redo search’ in this area. Then at Step 17 pins appear in the newly searched area and the system takes it back to Step 13.

Also alternatively, from Step 14 the user can go to Step 18 where the user taps the company name. This can also be accessed from Step 8 directly to Step 18. At Step 19 the specific company's profile is disclosed. At Step 20 the user taps the ‘view availability button and the user is taken to Step 22 and is taken to the specific company's availability calendar displaying available time slots for booking and then to Step 23 where the user taps an available time slot and the system proceeds to Step 26 through 30 as described below.

From Step 8 the user can move to Step 21 where the user taps the ‘more’ button for a specific company. If there are no available time slots Step 21A the user is taken to Step 19 where another specific company's profile is displayed. If there are available time slots Step 21B, the user is taken to Step 22 to that specific company's availability calendar displaying available time slots for booking. Step 23 the user taps an available time slot and an appointment is set and the user moves to Step 26 through 30 explained below.

From Step 8 the user can go to Step 24 where the user taps an available time slot button for a specific company and the user is taken to step 26 where the user taps on their preferred calendar. Step 27 the user taps on their preferred service and goes to Step 28 where the user is taken to the appointment checkout and summary page for that time slot. Step 29 is the payment process and at Step 30 the appointment is booked for the user for the chosen time slot.

Referring to FIG. 2A there is shown the face of a mobile device, a mobile phone or smartphone, which has opened the search page. There is a menu available 100, a search tab 101, a favorites tab 102 and a live chat help tab 103. A search by name can be entered at screen 104 with a search button 105. There is a current location screen 106 which is clickable to change location. There is a ‘day of the week’ screen 107 which is clickable to specify a day of the week and a time screen 108 which is clickable to specify time.

Searches can also be made on a plurality of category buttons 109 to easily search by category. This area may scroll up or down to see more categories. A special feature of the system is that, all on one screen, there are available for the user to search, by the plurality of categories 109, the name search (service or company) 104, the location 106, the day 107 and the time 108.

FIG. 2 B shows the search results from a typical search made on the mobile device. There is the menu 100, the search tab 101, the favorites tab 102 and the live chat 103.

A search by name 104 for ‘yoga’ has been made by using search tab 105. 25 search results have come up for yoga in Santa Monica, Calif. 127. There is a map tab 110. Three results for Yoga Studios are shown, Yoga Studio 1, 111, Yoga Studio 2, 112 and Yoga Studio 3, 113.

There are available times for appointments listed for each Studio, 114 for Studio 1, 115 for Studio 2 and no times available 116, for Studio 3. Each Studio listed has a “more” button to ask for more appointment times to be shown 117, 118 and 119. There is a heart in each Studio listing, 120, 121 and 122. The user can click on a heart to put that Studio in their favorites list.

There are also stars in each listing that shows a rating of the company, which can be zero to 5 stars, or any chosen amount, 123, 124 and 125. The results shown can be scrolled up or down 126 to show more listings of companies. There is a “can't find it” button 128 that allows users to add a company to the system database.

Referring to FIG. 3A, there is shown a mobile map display which can be accessed by clicking on the map icon 110 of FIG. 2B, to show a map of display of the search results of FIG. 2B.

There is still the menu icon 100, the search icon 101 the favorites icon 102, the search by name icon 104 and the search button 105. The map icon 128 shows the current map of the searched area 129. Seven pins 130 are shown on the map as pictured, but the user can drag the map in all directions 132 to show different areas. Each of the pins 130 show a specific company to display basic information and available times, as shown in FIG. 2B. A redo search area button 131 allows the user to search a new area the map may have been moved to.

FIG. 3B shows what occurs if the user clicks on one of the seven icons shown 130. The icons are colored black and if one is clicked, it turns white 133. The information for the company 111 at that chosen icon location is shown. Specific company information and available times from FIG. 2B appear 134. The user can click back on the map to revert back to the full map screen shown in FIG. 3A. The user can also drag the map to different areas 138.

A special feature of the system is that when the user clicks on an available appointment time 114, the system takes the user directly to checkout box 28 of FIG. 1, which is a great timesaver.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What we claim is:

1. A computer implemented method of searching for services desired by a user comprising:
compiling a database of establishments available for the user to search;
the database comprising a profile about each establishment;
the profile comprising one or more of, the establishment's category of services provided; the location and the available appointment days and times for providing the services;
providing a search program operable by a computer processor accessible by a user operating a computer or a mobile device;
in which the user can search for a service by selecting one or more of a category of service, name of an establishment, a location, or a date and time available for an appointment;
the user confirming an available appointment with an establishment directly from their computer or mobile device.

2. The method of searching for services desired by a user of claim 1 wherein the user can select their current location or a specific other location.

3. The method of searching for services desired by a user of claim 1 where the user searches by the day of the week.

4. The method of searching for services desired by a user of claim 1 where the user searches by the time of day.

5. The method of searching for services desired by a user of claim 1 where the user searches by category or name of an establishment and the availability results are listed by matching the words searched.

6. The method of searching for services desired by a user of claim 1 where the user searches by location and the availability results are listed matching the user's location from nearest to farthest.

7. The method of searching for services desired by a user of claim 6 wherein the system provides a map of the location which the user can access.

8. The method of searching for services desired by a user of claim 7 wherein the map includes icons which identify establishments providing the service desired by the user.

9. The method of searching for services desired by a user of claim 1 where a user can save a list of favorite establishments in their computer or mobile device.

10. The method of searching for services desired by a user of claim 1 where a user can review existing appointments, a history of their completed appointments and their prior receipts.

11. The method of searching for services desired by a user of claim 1 where a user can review existing appointments, a history of their completed appointments and their prior receipts while also viewing the user's calendar.

12. The method of searching for services desired by a user of claim 1 where a user can add an establishment to the database.

13. The method of searching for services desired by a user of claim 1 where a user can choose a specific employee of the establishment for the service.

14. The method of searching for services desired by a user of claim 1 where the establishments are rated by the users.

15. The method of searching for services desired by a user of claim 1 where the establishments are rated by the users and the ratings are shown as part of the search results.

16. The method of searching for services desired by a user of claim 1 where any payments required at the time of confirming an appointment are processed directly between the user and the establishment.

17. The method of searching for services desired by a user of claim 1 in which, all on one screen, there are available for the user to search, by a plurality of categories, a name search, a location, a day or a time.

18. The method of searching for services desired by a user of claim 1, when the user chooses an available appointment time, the system takes the user directly to checkout.
